(19) United States
(12) Patent Application Publication
(10) Pub. No.: US 2011/0254459 A1
(43) Pub. Date: Oct. 20, 2011

(54) COLOR PROJECTION LAMP

(76) Inventors: R. Aaron Falk, Newcastle, WA (US); Tram Pham, Renton, WA (US)

(21) Appl. No.: 13/088,176

(22) Filed: Apr. 15, 2011

Related U.S. Application Data
(60) Provisional application No. 61/325,220, filed on Apr. 16, 2010.

(51) Int. Cl. H05B 41/16; F21S 4/00

(52) U.S. Cl. 315/250; 362/311.01; 362/311.02

(57) ABSTRACT

A lamp that produces an infinitely variable range of time, space, and color patterns. The lamp includes a plurality of colored light sources that produce light in at least two different visual spectrums, a single modulation device that generates a modulation scheme for each of the plurality of light sources, a display screen, and a mask that masks off at least a portion of light illuminating the display screen. The generated modulation scheme is produced at a predefined intensity level. A controller selectively alters delivery of the modulation scheme to each of the plurality of light sources. A first switch allows a user to select one of a plurality of modulation schemes. A second switch allows a user to alter the predefined intensity level. A third switch allows a user to select one of a plurality of modulation rates.

### PRIORITY CLAIM

This application claims priority to U.S. Provisional Patent Application 61/325,220 filed Apr. 16, 2010 and is incorporated herein by reference.

### BACKGROUND OF THE INVENTION

The background and history of the use of light emitting diodes (LEDs) in color displays and lamps is extremely rich. Nonetheless, the prior art can be placed into two categories—displays and color illuminators. LED displays are typified by U.S. Pat. Nos. 4,780,621; 5,708,452; 5,836,676; 5,990,802; and 6,639,574. The inventions in these patents use individual or red-green-blue groupings of LEDs that are used as pixels to form a visual pattern of varying intensity and color. The pattern can be as simple as blinking Christmas tree lights (U.S. Pat. No. 4,780,621) or in the form of arrays that produce images as in a standard computer screen or television display. In all cases, direct viewing of the LED pixels is assumed.

LED based lamps are typified by U.S. Pat. Nos. 4,777,408; 4,922,154; 5,036,248; 5,575,459; 5,752,766; 6,016,038; 6,150,774; 6,166,496; 6,567,009; 6,577,080; 6,956,338; 7,038,398; 7,064,498; 7,186,003; 7,427,840. All of these patents seek to use multiple colored LEDs to produce illumination of a specified color. That is to say they move completely away from direct viewing of individual pixels to viewing an aggregate of the combined LED outputs. Basically a color controlled version of an incandescent or fluorescent lamp. The illumination color is controlled through a variety of techniques; all are simply variations on adjusting the average current flowing through the LEDs. The most sophisticated techniques use computer control and time variations to produce pleasing visual effects.

U.S. Pat. No. 7,427,840 describes the ability to produce apparent motion or spatial effects through uniformly illuminating a colored image. For example they note that the red section of an image will appear black when illuminated with green light and red under white illumination. Note that the illumination is uniform and the apparent color variations are due to the colors of the item being illuminated. Also, this inventor points out that their analysis is somewhat flawed in that inks, dyes, and paint are typically composite colors where as LED's are single colors. For example the human eye sees a dye with the combination of red and green as yellow. However, when this dye is illuminated with a yellow LED it will appear black (the dye has no actual yellow component).

The LED patents to date therefore are either in the form of pixels for direct viewing or in the form of uniform color illumination. The current invention rejects both approaches in order to produce a pleasing and artistic projection lamp that produces an infinitely variable range of time, space, and color patterns.

### SUMMARY OF THE INVENTION

The present invention provides a pleasing and artistic projection lamp that produces an infinitely variable range of time, space, and color patterns. An exemplary lamp includes a plurality of colored light sources that produce light in at least two different visual spectrums, a single modulation device that generates a modulation scheme for each of the plurality of light sources, a display screen, and a mask that masks off at least a portion of light illuminating the display screen. The generated modulation scheme is produced at a predefined intensity level.

In one aspect of the invention, the mask includes a pattern of light blocking material and is a diffusive, refractive or reflective surface.

In another aspect of the invention, the screen is at least one of a diffusive, refractive or reflective surface. In one embodiment, the screen is cylindrical.

In still another aspect of the invention, a controller selectively alters delivery of the modulation scheme to each of the plurality of light sources.

In yet another aspect of the invention, a switch allows a user to select one of a plurality of modulation schemes. Another switch allows a user to alter the predefined intensity level. A third switch allows a user to select one of a plurality of modulation rates.

### BRIEF DESCRIPTION OF THE DRAWINGS

Preferred and alternative examples of the present invention are described in detail below with reference to the following drawings:

FIG. 1 is a diagram of an exemplary system formed in accordance with an embodiment of the present invention;

FIG. 2 is an exemplary timing diagram used by the components of the system of FIG. 1; and

FIG. 3 is a flowchart of an exemplary process performed by the system of FIG. 1.

### DETAILED DESCRIPTION OF THE PREFERRED EMBODIMENT

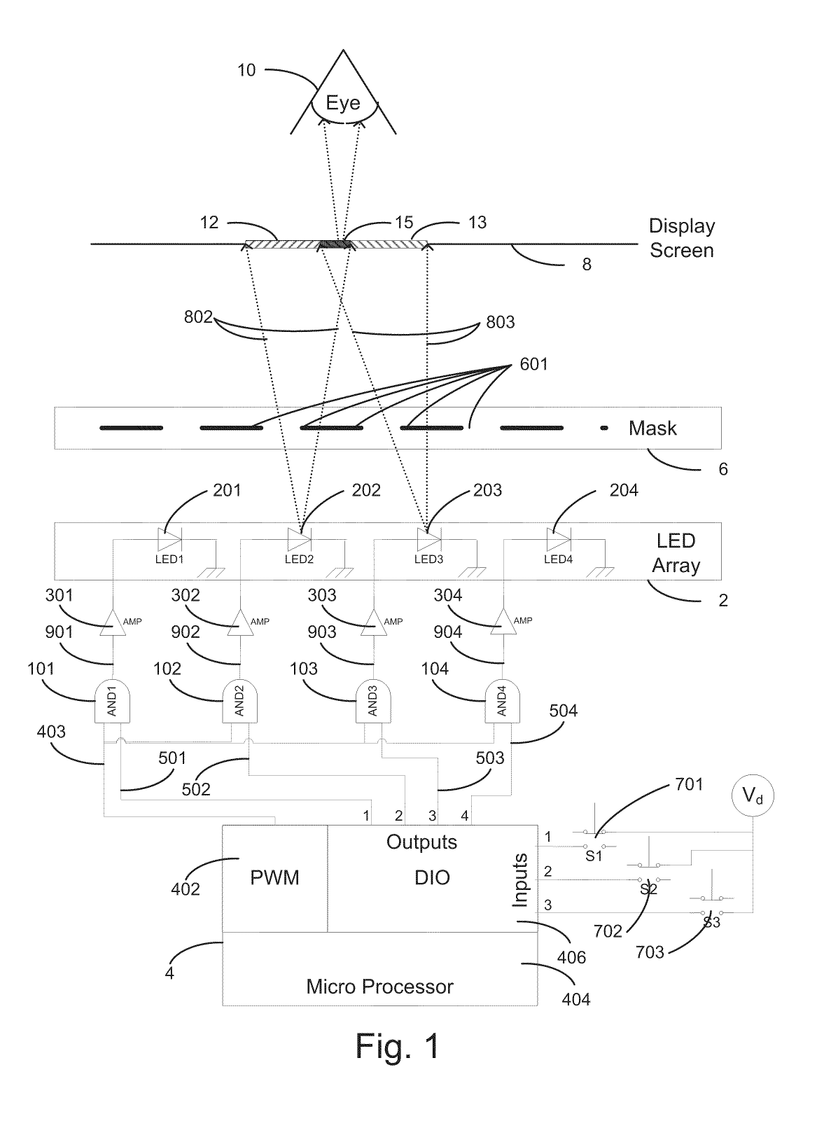

A basic block diagram of the current invention is shown in FIG. 1. The invention includes an illuminator array 2 having a spatial array of individual LEDs with four LEDs 201, 202, 203, and 204 being shown in this example. Said LEDs, 201, 202, 203, and 204, being of differing colors. Each LED 201, 202, 203, and 204 is independently driven by a pulse width modulator (PWM) 402 with a PWM output 403 so as to adjust the LED intensity.

In one embodiment the PWM 402 is contained within a microcontroller 4 such as a PIC18F4550 from Microchip Corporation. The microcontroller 4 of this sort is a combination of a general purpose microprocessor 404 and a set of peripherals, which typically includes a pulse width modulator 402 and digital input/output (DIO) 406. Although an independent PWM could be used to drive each LED, there is an advantage to using a single PWM 402 and time-multiplexing its output through a set of AND gates 101, 102, 103, and 104 with drive outputs 901, 902, 903, and 904 respectively. This approach reduces the parts count and overall cost (a typical inexpensive microcontroller 4 has only one PWM 402 built in).

The desired LED brightness is achieved with the single PWM 402 by overdriving the peak current from the amplifiers (AMPs) 301, 302, 303, and 304 for the individual LEDs 201, 202, 203, and 204 to produce a desired average current. Digital outputs (DO) 501, 502, 503, and 504 from the microcontroller 4 are used to select which LED 201, 202, 203, and 204 is turned on in a cyclic fashion. Selection is through use of AND gates 101, 102, 103, and 104. The cycle rate is chosen to be faster than the eye response rate (˜30 Hz) so that the illumination appears to be steady, without noticeable flickering.

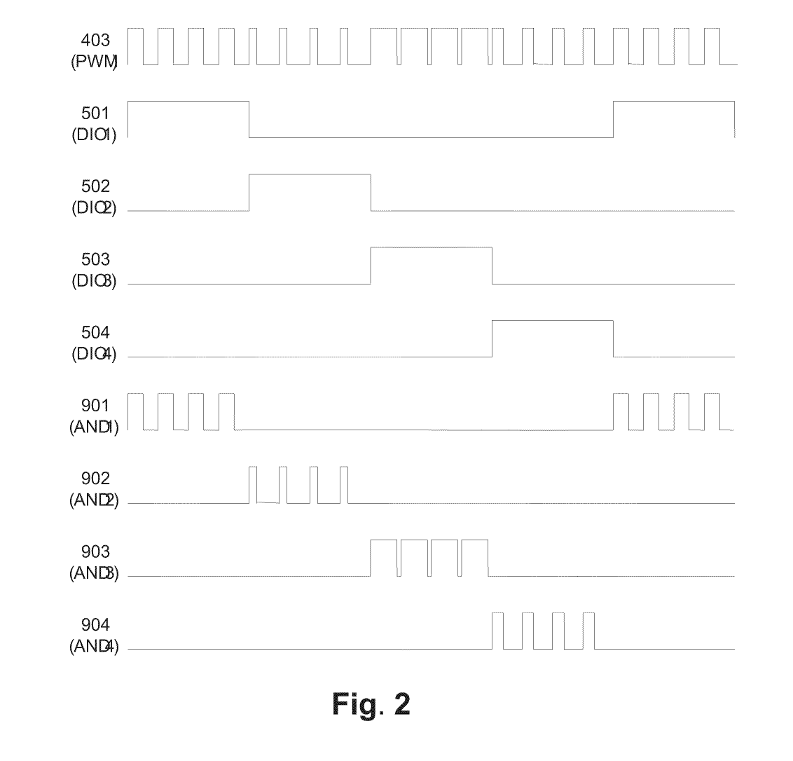

An exemplary timing diagram for a single cycle of this time multiplexing process is shown in FIG. 2. The on-off (logic high-logic low) state versus time for each of the corresponding digital outputs is shown in this diagram. As seen, each LED 201, 202, 203, and 204 is selectively activated by driving one input of the corresponding AND logic gate 101, 102, 103, and 104 high, which allows the PWM output 403 to drive the LED 201, 202, 203, and 204 for which the corresponding AND gate 101, 102, 103, and 104 input is high. As shown in the diagram, the duty cycle of the PWM output 403 is independently set for each LED 201, 202, 203, and 204 being driven.

The purpose of the above described circuit is to allow the intensity of each LED 201, 202, 203, and 204 to be varied in time by an algorithm operating within the microcontroller 4. Any equivalent circuit (e.g. one using linear drives and a digital-to-analog conversion) will suffice. Additionally, hardwired digital and analog circuits could be used to produce the desired time variations (e.g. each LED 201, 202, 203, and 204 could be directly wired to an oscillator). However, use of a microcontroller allows new algorithms to be introduced without redesign and fabrication of new circuitry.

Switches 701, 702, and 703 are used to adjust the overall intensity, time variation process (algorithm) and rate of the LEDs 201, 202, 203, and 204 as described in the flow chart description to follow.

The key to the current invention is that the LED illumination (802 for LED 102 and 803 for LED 103 show) passes through a mask 6 and then onto a projection (display) screen 8 where it is viewed by an observer 10. The projection screen 8 would typically be a diffusive surface (to allow viewing at all angles). The screen can be viewed in either a transmission mode (as shown) or a reflection mode (i.e. projection onto a wall).

The mask 6 includes a set of mask elements 601. The mask elements 601 may include patterns of opaque and transmissive components as exemplified in FIG. 1. The mask elements 601 could also include a transparent material (e.g. plastic or glass) with a light blocking material (e.g. paint) placed in a pleasing pattern on the surface. The mask elements 601 could also include refractive or reflective elements or elements (e.g. dyes) that preferentially transmit certain colors. The mask 6 could also have many layers along the optical axis or be fully three dimensional (e.g. objects embed in a clear matrix such as plastic or glass).

The spacing between the individual LEDs 201, 202, 203, and 204 in the illuminator array 2, along with the spacing between the illuminator array 2, mask 6, mask elements 601 and projection screen 8 are selected such that each LED 201, 202, 203, and 204 only illuminates limited portions or areas of the screen 8 with other portions being blocked. Two such illumination portions 12 and 13 are shown in FIG. 1. The spacing between the mask elements 601 is further constructed that the illuminated portions 12 and 13 will overlap 15 to a desired degree.

An example for two illuminated portions 12 and 13 from LED 202 and LED 203 respectively is shown in FIG. 1. The areas of illuminated portions 12 and 13 that do not overlap will appear as the base color of the LED 202 and 203 respectively, in this example red from LED 202 and blue from LED 203. The area in which illuminated portions 12 and 13 overlap 15 will appear to the eye as a combined color, purple, even though purple is not one of the LED colors. Changing the relative intensities for LED 202 and LED3 203 will shift the combined color from pure red through purple to pure blue. In addition an apparent motion of the illuminated portion will occur as one LED is dimmed and another made brighter. Use of multiple LEDs (e.g. 201, 202, 203, and 204 shown) and multiple mask elements 601 will produce multiple areas of overlap of differing colors. Modulation of the LED intensities with a time varying sequence will cause all the colors to shift and apparent motion to occur.

Examples of time sequences include:
Each LED 201, 202, 203, and 204 having a sine wave modulation with different phases
Each LED 201, 202, 203, and 204 have a sine wave modulation, each with different frequency
A pseudo-random modulation sequence
Triangle modulation with different phases and frequencies
Response to an audio or video signal
Basically any set of time varying electrical signals that produce relative variations of the illumination intensity from the LEDs 4.

Note that the illuminator array 2, mask 6 and screen 8 are shown as planar in FIG. 1 in order to simplify the drawing. All of these components can be formed into any desirable geometric shape and all can be 3 dimensional. Example images may be produced with a cylindrically shaped mask 6 and screen 8. Variations can include shapes such as Christmas trees, stars, space shuttles, etc.

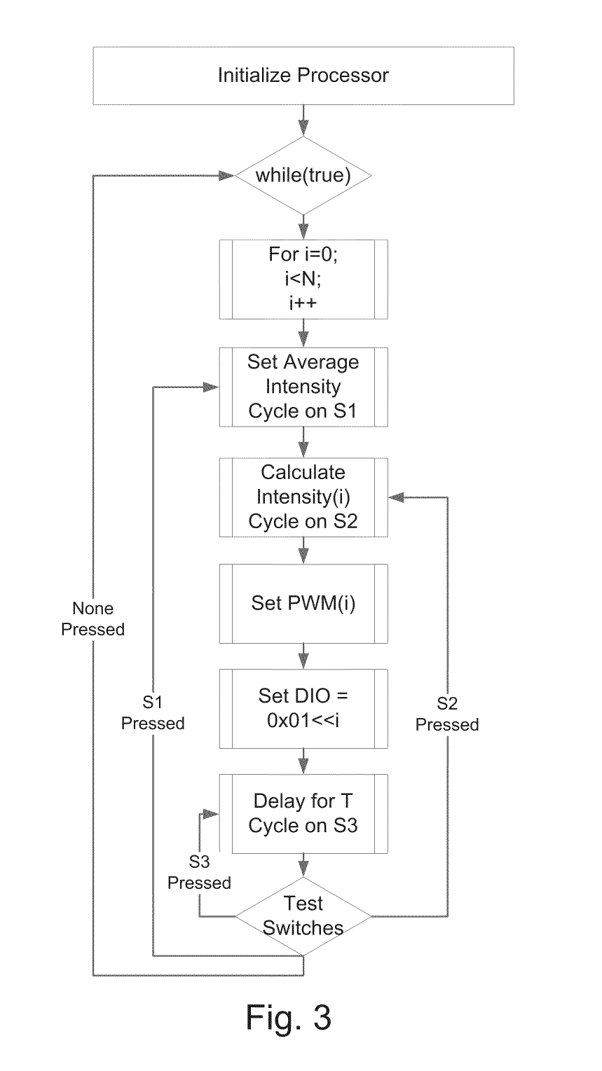

FIG. 3 is a software flow diagram for the basic firmware in the microprocessor 404. The firmware flows through an endless loop where-in for each of the N LEDs
1. An overall intensity (average intensity) for all the LEDs is set
2. An updated individual modulation intensity for the current modulation process for the ith LED is calculated
3. The PWM duty cycle for the i^{th} LED is set as the product of the average and individual modulation intensities
4. DIO for the i^{th} LED is selected to turn it ON
5. The i^{th} LED remains ON for a time T
6. During this time the switches are polled to determine if any have been switched
7. Loop through all N LEDs
8. Loop back through endless While loop

As a specific example, let the time variation process be a sine wave with unique frequency F(i) for the i^{th} LED
1. The average intensity is set at 75% of full scale
2. The next individual modulation intensity for the i^{th} LED based on the next step in a sine wave at F(i) is calculated from the previous steps via standard numerical methods.
3. The PWM(i) is scaled and set as the product of the average and individual modulation intensities
4. The i^{th} LED is then turned on via DIO
5. The state is held stationary (LED(i) is on) for a time T during which the state of the switches is polled.
6. All LEDs are looped through
7. Process is repeated

Pressing switch 701 causes the average intensity to change. In this simple arrangement it is assumed that the microprocessor 404 is preprogrammed with a set of average intensity levels (e.g. 100%, 75%, 50%, 25%) and pressing switch 701 cycles through these levels.

Pressing switch 702 causes a new modulation sequence (as described in above) to be selected for step two. For example a sine wave sequence may be changed to a triangle wave sequence. In this arrangement it is assume that the microprocessor 404 is preprogrammed with a set of modulation sequences and pressing switch 702 cycles through the sequences.

Pressing switch 703 causes the timing rate to change by changing the While loop time period, T. The time period T sets the modulation speed. In this simple arrangement it is assume that the microprocessor 404 is preprogrammed with set of values of T and pressing switch 703 cycles through those values.

It can be appreciated that more complex control of these three variables is possible.

In one embodiment, the mask 6 includes a rectangular array of holes that are located behind the display screen 8 that is curved. In another embodiment, the mask 6 includes a ‘crazy quilt’ array of holes. In another embodiment, the mask 6 includes artistically painted mask.

While the preferred embodiment of the invention has been illustrated and described, as noted above, many changes can be made without departing from the spirit and scope of the invention. For example, light sources other than LEDs may be used, such as incandescent lamps and colored filters may be used on a larger scale device. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A lamp apparatus comprising:
a plurality of colored light sources configured to produce light in at least two different visual spectrums;
a single modulation device configured to generate a modulation scheme for each of the plurality of light sources;
a display screen; and
a mask configured to mask off at least a portion of light illuminating the display screen,
wherein the generated modulation scheme is produced at a predefined intensity level.

2. The apparatus of claim 1, wherein the mask comprises a pattern of light blocking material.

3. The apparatus of claim 1, wherein the mask comprises at least one of a diffusive, refractive or reflective surface.

4. The apparatus of claim 1, wherein the mask is located at a first distance from the plurality of LEDs and the screen is located at a second distance from the plurality of light sources, the second distance being greater than the first distance.

5. The apparatus of claim 4, wherein the screen comprises at least one of a diffusive, refractive or reflective surface.

6. The apparatus of claim 4, wherein the screen is cylindrical.

7. The apparatus of claim 1, wherein the mask comprises at least one additional mask layer configured to mask off at least a portion of light illuminated by at least one of the plurality of light sources, at least one additional layer being located at a distance from the plurality of light sources that is greater than the distance the first mask layer is away from the plurality of light sources.

8. The apparatus of claim 7, wherein the at least one additional mask layer comprises at least one of a diffusive, refractive or reflective surface.

9. The apparatus of claim 1, further comprising a controller configured to selectively alter delivery of the modulation scheme to each of the plurality of light sources.

10. The apparatus of claim 1, further comprising a switch configured to allow a user to select one of a plurality of modulation schemes.

11. The apparatus of claim 1, further comprising a switch configured to allow a user to alter the predefined intensity level.

12. The apparatus of claim 1, further comprising a switch configured to allow a user to select one of a plurality of modulation rates.

13. The apparatus of claim 1, wherein the plurality of colored light sources comprise light emitting diodes (LEDs).

14. A method comprising:
generating light in at least two different visual spectrums from a plurality of colored light sources;
sending a modulation signal to each of the plurality of light sources using a single modulation device;
masking off at least a portion of the generated light; and
illuminating a screen with a portion of the generated light not masked off,
wherein the generated modulation signal is produced at a predefined intensity level.

15. The method of claim 14, further comprising selectively altering delivery of the modulation signal to each of the plurality of light sources.

16. The method of claim 14, further comprising altering the modulation signal based on a received user selection.

17. The method of claim 14, further comprising altering an intensity level based on a received user selection.

18. The method of claim 14, further comprising altering a modulation rate based on a received user selection.
